(19) United States
(12) Patent Application Publication
(10) Pub. No.: US 2009/0017914 A1
(43) Pub. Date: Jan. 15, 2009

(54) INTERPERIPHERAL USB IN A WAGERING GAME MACHINE

(75) Inventor: Muthu Velu, Addison, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 12/161,631

(22) PCT Filed: Jan. 18, 2007
(86) PCT No.: PCT/US07/01464

§ 371 Date: Jul. 21, 2008

Related U.S. Application Data
(60) Provisional application No. 60/743,151, filed on Jan. 20, 2006.

(51) Int. Cl. A63F 9/24; G06F 19/00

(52) U.S. Cl. 463/40; 463/16

(57) ABSTRACT

A computerized wagering game system includes a gaming module operable to conduct a wagering game on which monetary value can be wagered, a first USB-OTG device operable to function as a USB host and to communicate directly with a second USB device. In various embodiments, the second USB device is another device within the wagering game machine, or is an external device such as a cellular telephone, digital music player, digital camera, or memory stick.

### RELATED APPLICATION

This patent application claims the priority benefit of U.S. Provisional Patent Application Ser. No. 60/743,151 filed Jan. 20, 2006 and entitled “INTERPERIPHERAL USB IN A WAGERING GAME MACHINE”, which is incorporated herein by reference.

### FIELD OF THE INVENTION

The invention relates generally to computerized wagering game systems, and more specifically to using USB for interperipheral communication in a wagering game machine.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, WMS Gaming, Inc.

### BACKGROUND

Computerized wagering games have largely replaced traditional mechanical wagering game machines such as slot machines, and are rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they must be fair, they must provide sufficient feedback to the game player to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer or other game players to facilitate game play and to provide an entertaining game playing environment, but rely upon the presentation of the game and environment generated by the wagering game machine itself. Incorporation of audio and video features into wagering games to present the wagering game, to provide help, and to enhance the environment presented are therefore important elements in the attractiveness and commercial success of a computerized wagering game system. Music and environmental effects are also played through speakers in some wagering game systems to enhance or complement a theme of the wagering game. These sounds typically accompany video presentation of the wagering game on a screen, which itself often includes animation, video, and three-dimensional graphics as part of presentation of the wagering game.

The variety of components found in a wagering game machine are typically under the control of the processor, but often receive or handle data to be used in other peripheral components. Management of each of the components, and routing data to the variety of peripheral devices used in a particular wagering game machine, can make modern wagering game systems even more complex than the personal computer systems in common use today. Coordination of operation of each of the parts and coordination of data transfer between peripherals can consume a significant portion of the processing power and bus bandwidth available in a typical wagering game machine, leaving fewer resources for other tasks such as presentation of the wagering game.

### SUMMARY

One example embodiment of the invention comprises a computerized wagering game system including a gaming module operable to conduct a wagering game on which monetary value can be wagered, and a first USB-OTG device operable to function as a USB host and to communicate directly with a second USB device. In various embodiments, the second USB device is another device within the wagering game machine, or is an external device such as a cellular telephone, digital music player, digital camera, or memory stick.

### BRIEF DESCRIPTION OF THE FIGURES

FIG. 1 shows a computerized wagering game machine, as may be used to practice some embodiments of the invention.

FIG. 2 is a block diagram of a computerized wagering game machine as may be used to practice some embodiments of the invention.

FIG. 3 shows a wagering game system featuring a variety of USB-OTG devices operable to communicate directly with other USB devices, consistent with an example embodiment of the invention

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

The invention comprises in one example a computerized wagering game system including a gaming module operable to conduct a wagering game on which monetary value can be wagered, and a first USB-OTG device operable to function as a USB host and to communicate directly with a second USB device. In various embodiments, the second USB device is another device within the wagering game machine, or is an external device such as a cellular telephone, digital music player, digital camera, or memory stick.

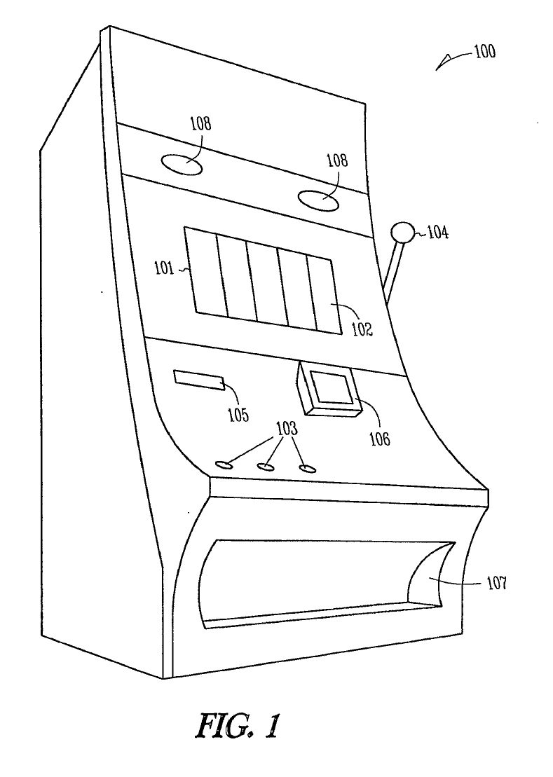

FIG. 1 illustrates a computerized wagering game machine, as may be used to practice some embodiments of the present invention. The computerized gaming system shown generally at 100 is a video wagering game system, which displays information for at least one wagering game upon which monetary value can be wagered on video display 101. Video display 101 is in various embodiments a CRT display, a plasma display, an LCD display, a surface conducting electron emitter display, or any other type of display suitable for displaying electronically provided display information. In some further embodiments, additional displays such as a bonus game display or top box display 102 are further operable to display electronically provided information to a wagering game player. Alternate embodiments of the invention will have other game indicators, such as mechanical reels instead of the video graphics reels shown at 103 that comprise a part of a video slot machine wagering game.

A game of chance is implemented using software within the wagering game, such as through instructions stored on a machine-readable medium such as a hard disk drive or nonvolatile memory. In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The game of chance implemented via the loaded software takes various forms in different wagering game machines, including such well-known wagering games as reel slots, video poker, blackjack, craps, roulette, or hold 'em games. In some further embodiments, a secondary game or bonus game is displayed on the secondary display 102, or other information such as progressive slot information or other community game information is displayed.

The wagering game is played and controlled with inputs such as various buttons 104 or via a touchscreen overlay to video screen 101. The touchscreen is used in some embodiments to display virtual buttons, which can have unique functions in some embodiments, or can duplicate the functions provided by the mechanical buttons 104 in other embodiments. In some alternate examples, other devices such as pull arm 105 used to initiate reel spin in this reel slot machine example are employed to provide other input interfaces to the game player. The player interface components are in this example contained within or mechanically coupled to the wagering game system, but in other embodiments will be located outside the wagering game system cabinet such as by a wired or wireless electronic connection to the wagering game system.

Monetary value is typically wagered on the outcome of the games, such as with tokens, coins, bills, or cards that hold monetary value. The wagered value is conveyed to the machine such as through a changer 106 or a secure user identification module interface 107, and winnings are returned such as via a returned value ticket, a stored value card, or through the coin tray 108. Sound is also provided through speakers 109, typically including audio indicators of game play, such as reel spins, credit bang-ups, and environmental or other sound effects or music to provide entertainment consistent with a theme of the computerized wagering game. In some further embodiments, the wagering game machine is coupled to a network, and is operable to use its network connection to receive wagering game data, track players and monetary value associated with a player, and to perform other such functions.

In other embodiments, the computerized wagering game system takes one or more other forms, such as a mobile or portable wagering game device, a server-based wagering game device, or a networked wagering game system. These other computerized wagering game system embodiments need not contain all features of the wagering game system of FIG. 1, which does not limit the scope of a computerized wagering game but is provided as an example only.

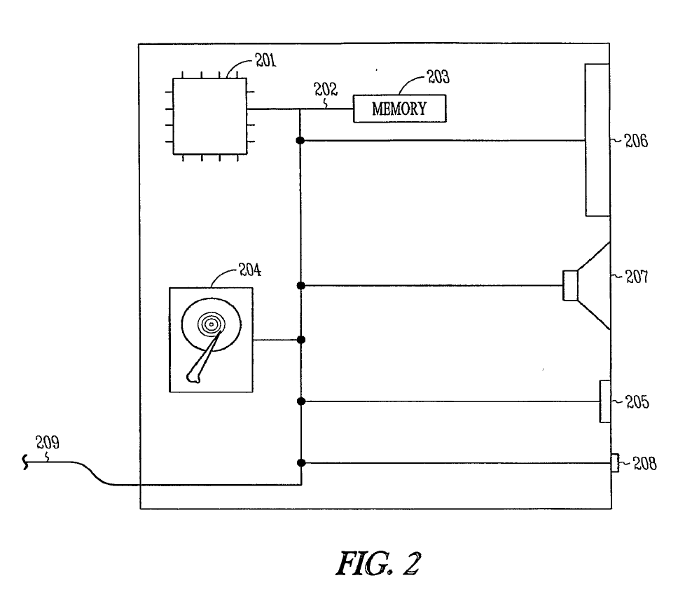

FIG. 2 shows a block diagram of an example embodiment of a wagering game system, as may be used to practice some embodiments of the invention. The wagering game system includes a processor 201, which is sometimes called a microprocessor, controller, or central processing unit (CPU). In some embodiments, more than one processor is present, or different types of processors are present in the wagering game system, such as using multiple processors to run gaming code, or using dedicated processors for audio, graphics, security, or other functions. The processor is coupled via a bus 202 to various other components, including memory 203 and nonvolatile storage 204. The nonvolatile storage is able to retain the data stored therein when power is removed, and in various embodiments takes the form of a hard disk drive, nonvolatile random access memory such as a compact flash card, or network-coupled storage. Further embodiments include additional data storage technologies, such as compact disc, DVD, or HD-DVD storage in the wagering game system.

The bus 202 also couples the processor and components to various other components, such as a value acceptor 205, which is in some embodiments a token acceptor, a card reader, or a biometric or wireless player identification reader. A touchscreen display 206 and speakers 207 serve to provide an interface between the wagering game system and a wagering game player, as do various other components such as buttons 208, pullarms, and joysticks. A network connection 209 is also provided, and in various embodiments is operable to report accounting information, download new game or multimedia content, or to facilitate participation in a cooperative game such as a progressive slot pool. These components are located in a wagering game machine cabinet such as that of FIG. 1 in some embodiments, but can be located in multiple enclosures comprising a wagering game system or outside a wagering game machine cabinet in other embodiments.

In operation, the wagering game system loads program code from nonvolatile storage 204 into memory 203, and the processor 201 executes the program code to cause the wagering game system to perform desired functions such as to present a wagering game upon which monetary value can be wagered. This and other functions are provided by various modules in the computerized system such as an audio module, a game presentation module, or a touchscreen display module, where such modules comprise in some embodiments hardware, software, mechanical elements, manual intervention, and various combinations thereof.

The various hardware peripheral devices typically function at the direction of code executing on the processor 201. Some devices operate such that their operation or actuation is forwarded to the processor and the executing code for processing or response, such as receiving a button pus at button 208 or receiving value from value changer 205. Other elements, such as a mechanical slot reel in some embodiments, operate solely at the direction of the code executing on the processor and don't provide input to the processor. A complex wagering game system can have tens of different devices under control of the processor, all sharing the same bus and processing resources, taxing the abilities of even the most sophisticated systems.

A system in which Universal Serial Bus (USB) devices are coupled to one another such that they can exchange information between themselves is therefore provided in some embodiments of the invention, which will in various embodiments and to various degrees enable interperipheral communication while reducing the load on the processor or bus. An extension to USB known as USB On-The-Go, or USB-OTG. A device supporting USB-OTG does not require a USB host adapter for operation, but can be coupled to another device supporting USB-OTG directly for exchange of information between peripheral devices. More specifically, traditional USB devices are not capable of initiating USB data transfers, but can only respond to host requests. When devices are designed to support USB-OTG, the devices are capable of both traditional peripheral device operation and host operation. This is also known as dual-role device (DRD) operation, and enables communication between USB devices without intervention of a USB host controller coupled to and under direction of a processor such as 201 of FIG. 1 to facilitate data exchange.

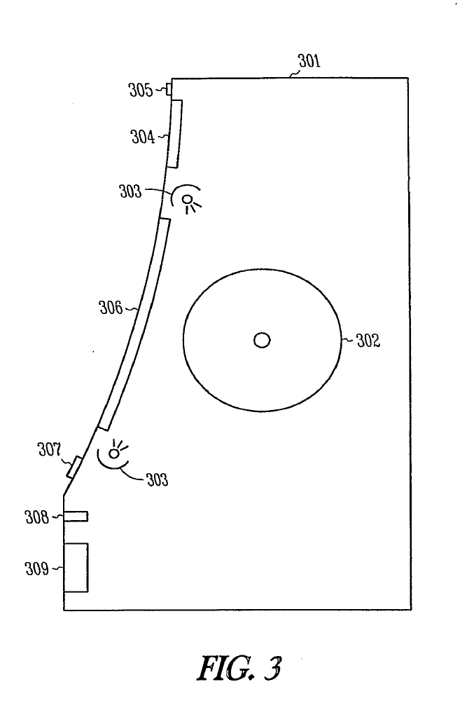

FIG. 3 shows one example of a wagering game system employing USB-OTG for interperipheral communication. The wagering game system 301 here includes a variety of peripheral devices, including mechanical reels 302 and reel lights 303, a top-box video display 304 and top box lights 305, a main video display 306 having transparent sections through which the mechanical reels can be observed and having touchscreen functionality, and a slot arm or handle not shown in the cutaway view of FIG. 3. Various embodiments also include one or more buttons 307, a USB port 308, a player tracking module, and a bill validator, ticket printer, coin acceptor, coin hopper, or other value management device 309. Various peripheral devices are coupled to one another via USB-OTG, or feature USB-OTG functionality, enabling them to communicate or exchange data directly with other USB devices.

For example, the lights 303 are in one embodiment coupled to the reels 302 via a USB-OTG connection, such that the reels are operable to control the reel lights. The reel lights will therefore not be coupled to the processor via the bus to be turned on and of by the processor, but can be turned on and off by switches, a controller, or another feature of the mechanical reel assembly 302 in coordination with reel spin, display of winning paylines, and for other purposes.

Similarly, the top box display 304 is in an example embodiment coupled to box lights 305 via USB-OTG, or to other peripherals such as top box speakers. The top box display assembly 304 is operable via the USB-OTG connection to exchange data and instructions directly with the USB-OTG attached devices, so the display controller can direct attached lights, speakers, or other peripheral devices to perform functions under the control of the display assembly 304.

In a more complex example, a display controller coupled to display 304 and part of the top box display assembly will comprise a storage device, such as a flash memory, DVD, or hard disk storage, and will be operable to exchange data with peripherals such as the display panel 304, lights 305, and top box speakers to display media stored on the storage device. The processor 201 and bus 202 are substantially removed from the presentation of stored media, as the individual images, video, sounds, and light controls no longer need be controlled by the processor and communicated via the bus, but can be performed in the top box based on a simple instruction. More specifically, the rendering of each change in the image displayed on the screen 304, actuation of each of the lights 305, and each binary element of the sounds played through a top-box speaker need not be handled by the processor and conveyed via the system bus to the individual component, but can be coordinated as transfers from USB-OTG coupled storage such as an optical disk drive or memory to one or more top box peripheral device controllers.

In another embodiment, a USB-OTG port 308 is provided to the wagering game players, game administrators, and to other wagering game system users. In one such example, a player can plug a USB device into the USB-OTG port 308 of the wagering game system to receive selected content, such as audio files, images, video, ring tones, screen savers, or other data. This can take place independent of the normal processor and system bus operation, offloading coordination of the data transfer from the processor and bus to the USB device and USB-OTG port in the wagering game system. Transfers will therefore not have a significant effect on wagering game performance, but can happen at full speed independent of other operation of the wagering game system.

Such a USB-OTG system further provides a degree of isolation between the USB-OTG port and the processor and bus of the wagering game system. In one such example, the USB-OTG port is coupled to a storage device such that the data stored on the storage device can be transferred to a user's device. Consider a system in which multimedia files are stored in the storage coupled to the USB-OTG port. A user is able to connect a device such as a flash drive, digital music player, or other USB device via the USB-OTG port and receive the stored data. This is used in some embodiments to convey digital music, videos, software, or other content to a user, either as a free part of using the wagering game system or as a bonus or award.

In a further example, the storage coupled to the USB-OTG port is a memory that can be read but not written via the USB-OTG port, and is therefore operable to convey information to a user via the port such that the user cannot alter the storage content via the port. One example application for such a system is to send multimedia files provided via the computer system while not risking a user modifying any content stored in the wagering game system. In another example, the machine is operable to provide accounting data, configuration data, or technical data such as a machine dump via the USB-OTG port, but the data cannot be altered or rewritten via the port.

The data is provided to the USB-OTG storage in one embodiment during the boot process, or via an administrator menu function. In other embodiments where USB-OTG memory is shared with the computer system, data provided to the USB-OTG port can be varied dynamically after attachment of a USB device or varying depending on the type of USB device attached. In one such example, the USB-OTG module detects a device plugged in via the USB-OTG port 308, and detects the type of device. In one embodiment, content appropriate to the device is automatically provided via the USB-OTG port, while in other embodiments a menu is provided showing content appropriate to the attached device. The menu shown on the touchscreen display enables the user to select the content downloaded to the attached USB device in embodiments where the USB-OTG storage is coupled to the processor and bus.

In another example, several peripherals are coupled to one another where at least one of the peripheral devices comprises a USB-OTG interface. For example, buttons 307, value or player tracking card input device 309, the touchscreen overlay of touchscreen display 306, and other input devices are all coupled to an input controller peripheral device in one embodiment, such that a single peripheral device with USB-OTG capability can serve as a single point of communication between the peripheral input devices and the wagering game system's bus and processor.

These examples illustrate how a wagering game system can use a USB-OTG port to facilitate communication between one peripheral device of the wagering game system and another USB device. The other USB device is in various embodiments another peripheral device in the wagering game system that can communicate directly with the USB-OTG device, or is an external device such as a user's cellular phone, memory stick, or digital music player.

Although specific embodiments have been illustrated and described herein, it will be appreciated by those of ordinary skill in the art that any arrangement that achieve the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

1. A computerized wagering game system, comprising:
a gaming module operable to present a wagering game on which monetary value can be wagered; and
a first USB-OTG device operable to function as a USB host and to communicate directly with a second USB device.

2. The computerized wagering game system of claim 1, wherein the second USB device comprises a part of the wagering game system, and is operable to exchange data directly with the first USB-OTG device.

3. The computerized wagering game system of claim 2, wherein the first USB-OTG device and the second USB device are devices within a wagering game system cabinet.

4. The computerized wagering game device of claim 1, wherein the second USB device is a USB-OTG device.

5. The computerized wagering game system of claim 1, wherein the first USB-OTG device is operable to exchange data with an external USB device.

6. The computerized wagering game of claim 5, wherein the external USB device comprises at least one of a cellular telephone, a personal digital assistant, a nonvolatile memory device, or a portable media player.

7. The computerized wagering game system of claim 1, wherein the first USB-OTG device is isolated from the wagering game system processor and bus during operation.

8. A method of operating a wagering game system, comprising:
presenting a wagering game on which monetary value can be wagered; and
operating a first USB-OTG device as a USB host such that the first USB-OTG device is operable to communicate directly with a second USB device.

9. The method of operating a wagering game system of claim 8, wherein the second USB device is operable to exchange data directly with the first USB-OTG device and comprises a part of the wagering game system.

10. The method of operating a wagering game system of claim 9, wherein the first USB-OTG device and the second USB device are devices within a wagering game system cabinet.

11. The method of operating a wagering game system of claim 8, wherein the second USB device is a USB-OTG device.

12. The method of operating a wagering game system of claim 8, wherein the first USB-OTG device is operable to exchange data with an external USB device.

13. The method of operating a wagering game system of claim 12, wherein the external USB device comprises at least one of a cellular telephone, a personal digital assistant, a nonvolatile memory device, or a portable media player.

14. The method of operating a wagering game system of claim 8, further comprising isolating the first USB-OTG device from the wagering game system processor and bus during operation.

15. A machine-readable medium with instructions stored thereon, the instructions when executed operable to cause a computerized wagering game system to:
present a wagering game on which monetary value can be wagered; and
operate a first USB-OTG device as a USB host such that the first USB-OTG device is operable to communicate directly with a second USB device.

16. The method of operating a wagering game system of claim 15, wherein the second USB device is operable to exchange data directly with the first USB-OTG device and comprises a part of the wagering game system.

17. The method of operating a wagering game system of claim 16, wherein the first USB-OTG device and the second USB device are devices within a wagering game system cabinet.

18. The method of operating a wagering game system of claim 8, wherein the first USB-OTG device is operable to exchange data with an external USB device.

19. The method of operating a wagering game system of claim 12, wherein the external USB device comprises at least one of a cellular telephone, a personal digital assistant, a nonvolatile memory device, or a portable media player.
